(19) United States
(12) Patent Application Publication
(10) Pub. No.: US 2004/0224296 A1
(43) Pub. Date: Nov. 11, 2004

(54) Method and web-based portfolio for evaluating competence objectively, cumulatively, and providing feedback for directed improvement

(75) Inventor: Carol Carraccio, Baltimore, MD (US)

Correspondence Address: SUGHRUE MION, PLLC, 2100 Pennsylvania Avenue, NW, Washington, DC, 20037-3213, US

(73) Assignee: University of Maryland, Baltimore

(21) Appl. No.: 10/428,926

(22) Filed: May 5, 2003

(51) Int. Cl. G09B 7/00

(52) U.S. Cl. 434/322

(57) ABSTRACT

Evaluation of competence in broad domains presents a major challenge to educators. Review of the literature on portfolio assessment suggests that it may be the ideal venue for assessing competence. The portfolio allows the learner to be creative and in the process facilitates reflective learning that is a key component in professional development. The portfolio also has the capacity to provide an infrastructure for the variety of assessment tools that are needed to evaluate the diverse domains of competence. In addition, the web-based infrastructure provides a platform for national study of the assessment tools that have been developed in the step towards evidence-based education. Thus the portfolio serves as an evaluation tool on three levels: 1) individual resident assessment, 2) program assessment based on aggregate data of resident performance and 3) provision of a national data base that facilitates the study of the educational process by studying assessment tools and impact of educational interventions. Discussed is the implementation of a web-based evaluation portfolio for residency training in a medical education program.

### FIELD OF INVENTION

Evaluation of competence, knowledge or other characteristics in an educational or professional field can involve numerous approaches and assessments. In all applications, it is desirable to provide a structured method and program where multiple objective criteria can be used both for evaluation by a teacher, professor and supervisor and as feedback for constructive and directed feedback for the pupil or employee. For instance, the Accreditation Council for Graduate Medical Education (ACGNE) and the American Board of Medical Specialties (ABMS) have partnered to bring about a paradigm shift to a competency-based system of medical education.¹ As a result, graduate level trainees will be expected to demonstrate competence in six domains: patient care, medical knowledge, interpersonal and communication skills, professionalism, practice-based learning and improvement, and systems-based practice. The curricula have yet to be developed, particularly to address the latter two domains of competence. However, aside from the specific criteria used, it is the evaluation of competence in these six very different domains that poses the greatest challenge.

### DESCRIPTION OF RELATED ART

Review of the literature on competence revealed a move to competency-based education in the late seventies and early eighties that was likely thwarted at the step of evaluation.² The single global evaluation that has traditionally been the hallmark of medical education is no longer a viable and valid method of assessment in a competency-based system of education. Not until the late nineties did the ACGME and ABMS resurrect this movement in the form of the “Outcomes Project.”¹ The requisites of evaluation of competence present a number of challenges. The tasks being evaluated should be “authentic.” Snadded et al. define authentic assessment as “assessment that looks at performance and practical application of theory.”³ Evaluators need to observe trainees performing tasks that they will be called upon to perform as practicing physicians. Direct observation is thus a critical component of the evaluative process. The outcome of the observation should be an assessment of whether the trainee has met the predetermined criteria for the achievement of competence for that particular task. Known as criterion-referenced assessment, it differs from norm-referenced assessment in that the former measures a learner against a predetermined threshold, whereas the latter measures the learner against others providing the well known bell-shaped curve for evaluation.⁴ Attainment of a threshold to achieve competence requires that the learner receive ongoing input about performance, making formative feedback a necessary component of the evaluation of competence.⁵ In searching for a method(s) to evaluate competence, the authors identified portfolio assessment as having the greatest promise. The portfolio, as defined by Mathers et al., is a “collection of evidence maintained and presented for a specific purpose.”⁶ Portfolio assessment then broadens the scope of evaluation by encompassing a variety of documents that can demonstrate the learner's achievement of competence. Known commercial web-based products only involve electronic publication of evaluation results. They do not contemplate the creative aspects of a portfolio including user update and evaluator interaction. The existing web-based evaluation portfolios also do not include a comprehensive set of assessment tools.

Evidence to date, in studying known unstructured portfolios, has demonstrated the difficulty of achieving what is typically considered acceptable standards of reliability and validity in educational measurement. Pitts et al. have studied the reliability of assessors in providing ratings of portfolios. In a study of 8 assessors, who examined 13 portfolios on 2 occasions, 1 month apart, using the kappa statistic (where k=0.8 is excellent agreement, 0.61-0.8 is substantial agreement, 0.41-0.60 is moderate agreement and 0.21-0.40 is fair agreement), inter-rater reliability for the global assessment of the portfolio was 0.38 and intra-rater reliability was 0.54.¹⁰ In a similar study in which assessors assigned a global rating for portfolios after independent examination and then again after paired discussions between assessors, Pitts et al. demonstrated that the interchange between assessors increased kappa from 0.26 to 0.50.¹¹

Similar pitfalls arise in attempting to study the validity of portfolios by attempting to compare them with current assessment methods. A random assignment of students to study (n=80) versus control groups (n=79), where the study group created an unstructured learning portfolio, showed no difference between the two groups on observed, structured clinical examination (OSCE) scores, but those students who submitted the portfolios for formative assessment had higher scores on the OSCE than those in the study group who did not submit the portfolios.¹² The lack of correlation between OSCE scores and whether the student used a portfolio may indicate that different outcomes are being measured. In contrast, in a trial of portfolios for 91 students doing an obstetrics and gynecology clerkship, modest but statistically significant correlation was demonstrated between final exam grades and performance of certain procedures, as well as final exam scores and amount of text written in the portfolio. There was also significant correlation between the same procedures and quantity of portfolio text.¹³ This correlation may indicate a generic rather than a specific relationship between the two measures, that is, both reflect the general activity level of the student. A growing literature on the use of portfolio learning as a process for continuing medical education (CME) demonstrates the same difficulties in portfolio assessment as those encountered for trainees; however, this has been balanced with practitioners investing more time in portfolio-based CME and attesting to portfolio enhancement of reflective practice.^{6,9, 14-16} Barriers to portfolio use are typically cited as the time investment for portfolio documentation and the uncertainty of how to use the portfolio as a learning tool.¹⁷

More limited evidence in the literature exists currently regarding the use of web-based portfolios in graduate medical education. Fung et al. describe the KOALA™, an internet-based learning portfolio for residents in obstetrics and gynecology.¹⁸ This portfolio encompasses patient logs, critical incidents, and the ability to summarize answers to clinical questions derived from evidence in the literature. One important finding from this study was that residents exposed to this system had a significant increase in their own perception of their self-directed learning abilities as measured by a self-directed learning readiness scale. In a web-based system for evaluation of internal medicine residents described by Rosenberg et al. at the University of Minnesota, the authors found improved compliance rates with completion of evaluation forms from 35-50% with traditional paper and pencil to 81-92% using the web-based format.¹⁹ On a Likert scale from 1 to 5, with 5 being strongly agree that the evaluation system is easy to use, a mean of 3.65 and 3.85 was calculated for resident and faculty responses, respectively. Two other aspects of the portfolio were highlighted: a dashboard that allowed residents to compare their evaluations with anonymous evaluations of their peers and a comment section on evaluations that were available to the program director only. In some ways, these capabilities lead one away from the basic tenets of competency-based evaluations, which supports a criterion rather than a norm-referenced system and formative feedback to the learner as a means for helping him/her to achieve competence. One other article reports the use of “SkillsBase,” a web-based learning portfolio for medical students at the University of Manchester.²⁰ This platform incorporates training materials as well as components for assessment. Other than obtaining feedback regarding utility, which was positive, the portfolio has not been studied.

### SUMMARY OF THE INVENTION

The present invention meets the challenges of developing multiple competency-based assessments. The present invention also addresses the issue of evaluating six broad and divergent domains of competence by identifying assessment tools to measure performance in each of these domains and for obtaining information about the students' assessments to redefine the evaluation criteria. The web-based assessment further provides significant reduction in time for assessment by the evaluator and self-assessment by the evaluated party.

### BRIEF DESCRIPTION OF DRAWINGS

FIGS. 1A-1E illustrate criteria of a student's self-assessment for levels of exposure to certain medical areas during medical rotation through a pediatric intensive care unit according to a preferred embodiment of the invention;

FIGS. 2A-2B illustrate criteria for a physical examination evaluation performed by a student according to a preferred embodiment;

FIGS. 3A-3G illustrate criteria for evaluation of a student's provision of patient care based on percentage of observed events and based on level of complexity of medical diagnoses;

FIGS. 4A-4B illustrate criteria for evaluation of a student's medical knowledge based on percentage of observed events and whether or not a particular action is taken by the student being evaluated;

FIG. 5 illustrates criteria for evaluation of a student's medical knowledge for a critically appraised topic according to a preferred embodiment;

FIG. 6 illustrates criteria for evaluation of a student's competence in evidence-based practice according to a preferred embodiment;

FIGS. 7A-7F illustrate criteria for evaluation of a student's ability to analyze his/her own practice based on percentage of observed events and whether or not a particular action is taken by the student being evaluated;

FIG. 8 illustrates criteria for evaluation of a student's competence in practice-based study approaches;

FIGS. 9A-9E illustrate criteria for a student's competence in systems-based practice based on percentage of observed events and whether or not a particular action is taken by the student being evaluated;

FIGS. 10A-10B illustrate criteria for evaluation of a student's interpersonal and communication skills based on percentage of observed events and whether or not a particular action is taken by the student being evaluated;

FIG. 11 illustrates parties that participate in a 360 degree evaluation of the student;

FIG. 12 illustrates a specimen of questions provided to a patient to evaluate the student;

FIGS. 13A-13B illustrate a specimen of questions provided to a colleague (residents, students, attending physician; director, health care team members) to evaluate the student;

FIGS. 14A-14D illustrate criteria for evaluation of attributes of a student's professionalism based on percentage of observed events and whether or not a particular action is taken by the student being evaluated.

### DETAILED DESCRIPTION OF PREFERRED EMBODIMENT

Review of the literature on portfolios highlights the similarities between the underpinnings of competency-based education/evaluation and portfolio-based learning/assessment. In both processes, the learner plays a pivotal role in driving the process.^{2,5} Competence requires the application of knowledge in the performance of authentic tasks, rather than mere acquisition of knowledge, and portfolios allow the learner to document these achievements. Formative feedback is critical to the achievement of competence and the value of portfolio assessment lies in its ability to foster reflective learning through feedback.^{3,5,7} In addition, reflective learning is thought to be the key to professional development.⁸ Parboosingh speaks to the essential component of learning as the ability to change practice as a result of one's learning. This activity requires the learner to reflect on learning needs, address the need through learning activities and then reflect on how this learning will impact future practice.⁹ This brings us to the greatest challenge in designing a portfolio—that is, balancing the creative or reflective component of the portfolio, which is difficult to evaluate, but key to reflective learning and thus professional development, with a structured component that affords a reliable and valid evaluative process.

A review of the use of portfolios in medical education translated into a number of lessons learned. First, to foster the reflective learning that is key to professional development, the portfolio must have a creative component that is learner driven. Second, the creative component must be balanced with a quantitative assessment of learner performance. Finally, both individual components of the portfolio and the portfolio in its entirety require reliability and validity testing.

To address the lessons delineated above, the invention includes a web-based system to evaluate performance in all six ACGME domains of competence for the University of Maryland pediatric residency training program. To facilitate the creative component of the web-based portfolio, the invention adopts several features: 1) a self-assessment of characteristics/attributes important to the practicing physician, 2) an individualized learning plan, 3) resident tracking of ability to meet educational objectives, 4) use of a threaded discussion board to engage the resident in bi-directional feedback with his/her mentor and 5) formal responses to critical incidents.

Self-assessment provides fertile ground upon which to build an individualized learning plan. The literature on self-assessment, however, reflects poor to modest correlations with other subjective and objective assessments, suggesting that a multitude of psychosocial factors are operative when one is asked to use self-assessment as a method of evaluation.²¹ Ward et al., in a recent review, have also pointed out the pitfalls of using conventional methods to study the reliability and validity of self-assessment measures.²² Patterns of over-assessment and under-assessment are not necessarily predictable.²³ Limited evidence suggests that a relative ranking model may increase the inter-rater reliability of experts, as well as the correlation between student and mentor assessments.²⁴ The present invention includes a self-assessment tool in which the learner rank orders a given set of abilities/attributes that are important to the practicing physician from one through 12, with one being his/her greatest strength and 12 being his/her greatest weakness.

Exemplary attributes include initiative, perseverance, ability to recognize limitations and admit errors; ability to work with others, attention to detail, time management, confidence, response to feedback, communication skills and striving for excellence. This self-assessment and creative component of the portfolio also allows for the subject to include additional attributes and to rank these additional attributes in addition to the common ones specifically included in the portfolio. In parallel with the student's self-assessment, a faculty mentor also assesses the attributes of the student to form a starting point of discussion with the mentee.

The second part of this invention comprises the creation of an individualized learning plan, in which the resident, with the help of the program director or associate program director, identifies three learning objectives for the academic year and several strategies by which to achieve them. Each resident completed this activity during the program orientation with the intent of revisiting and modifying the document on an annual basis. An instrument similar to the self-assessment form has also been developed for faculty mentors. Each resident's mentor will complete this assessment of his/her mentee at the beginning of each training year after the first year. This will allow for comparison between the learner's self-assessment and that of a mentor who knows the resident well.

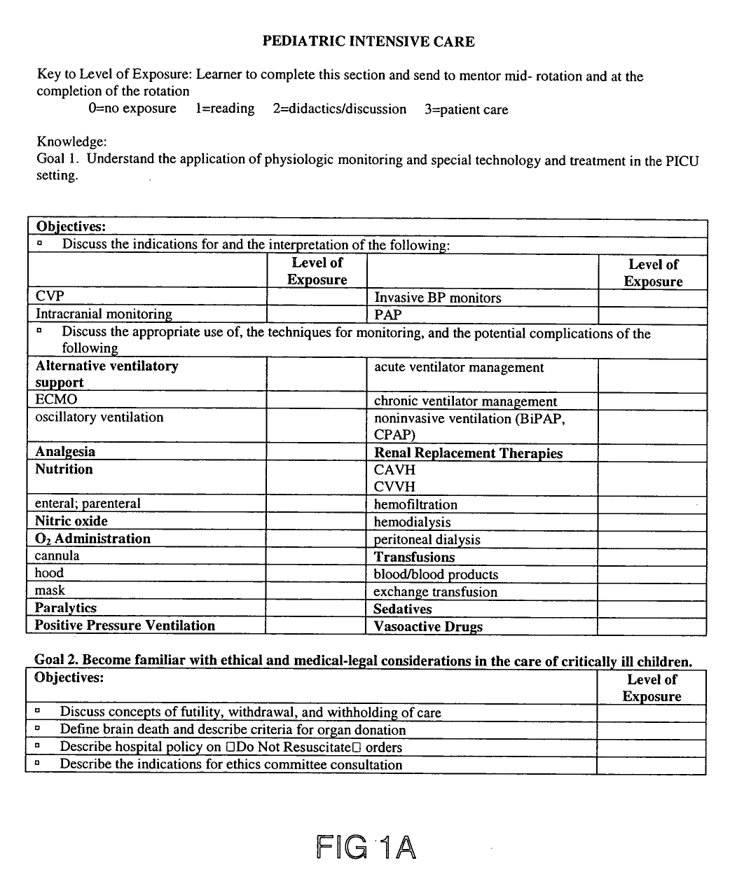

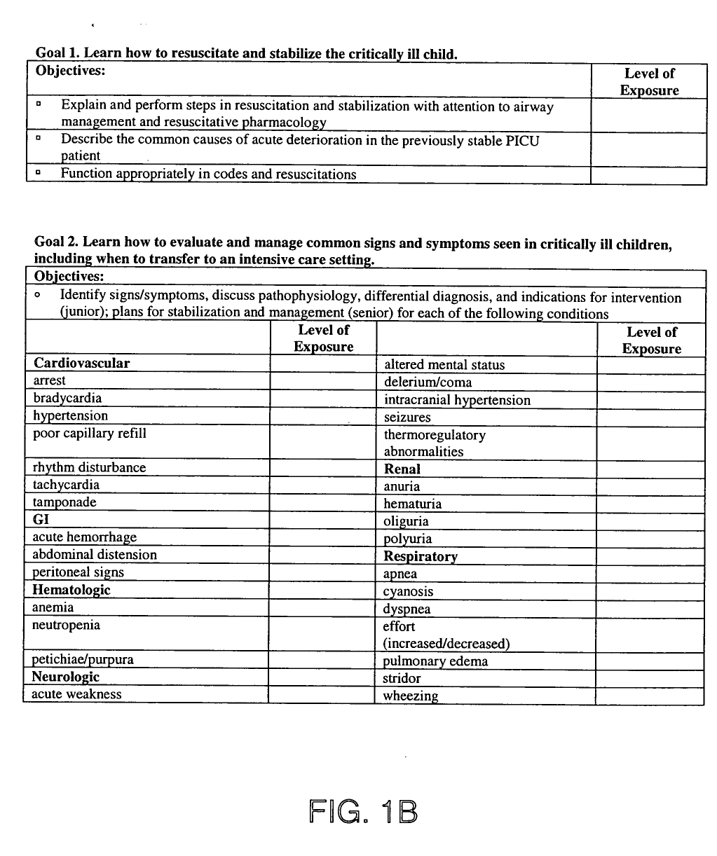

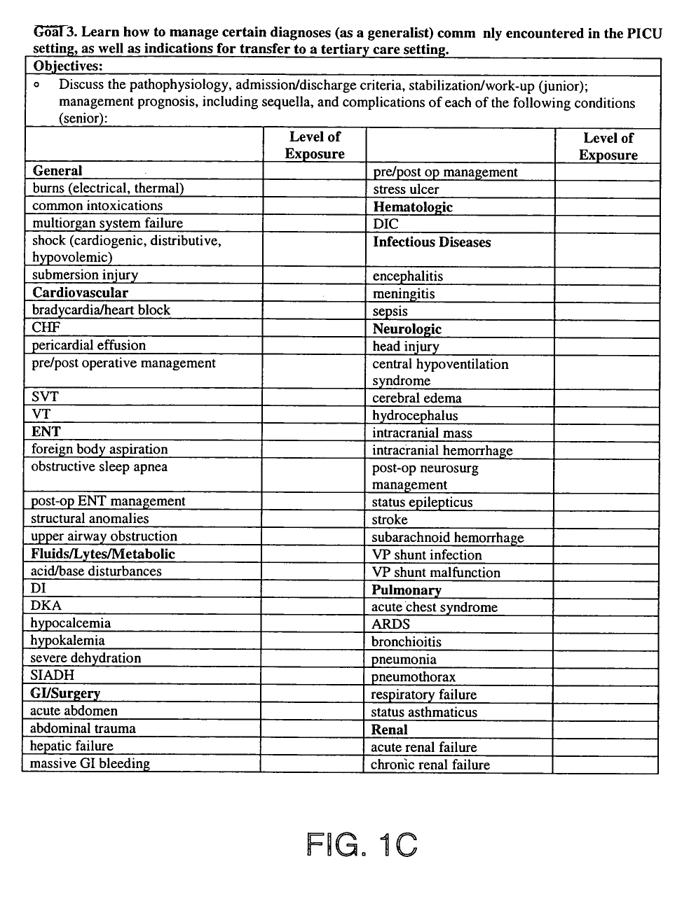

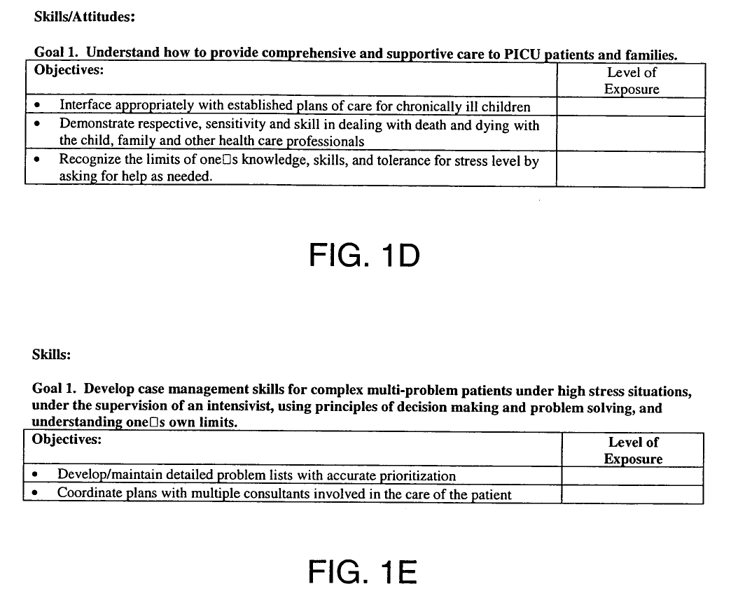

Residents will also be expected to monitor their own progress in meeting the learning objectives for each clinical experience. All of the goals and objectives were revised such that objectives are behaviorally based and thus measurable. The resident downloads these objectives from our web site at the beginning of each rotation and tracks level of exposure to each objective using the following key: 0=no exposure, 1=reading only, 2=didactic session/discussion, and 3=patient involvement. FIGS. 1A-1E illustrate an example of criteria used during a rotation through a pediatric intensive care unit.

The intent is to have the resident review these with the preceptor at the midpoint of the rotation, as well as to send them to his/her mentor for review. The latter is easily accomplished through the threaded discussion board that is built into the portfolio. The mechanism is structured in such a way that only mentors and mentees can communicate. The resident simply uploads their completed document into the message and sends it to his/her mentor. The discussion board is linked to the departmental email system so that the mentor receives an email containing the URL that takes him/her directly into the web-based portfolio through the hyperlink. This fosters the formative feedback that is critical to achievement of competence. The threaded discussion is not meant to take the place of face-to-face meetings, but to supplement these meetings that tend to occur infrequently during the training process.

Critical incidents, defined here as particularly positive or negative behavior, provide another opportunity for reflective practice. ^{14,25} Traditionally, these incidents can be recorded by one who has observed the learner engaging in the particular behavior as a means of giving feedback to the learner regarding performance. We have opted to include critical incidents in the portfolio, but have taken the opportunity to use them to promote reflection and impact on future practice. When a critical incident is initiated, the resident about whom it has been written is expected to respond in writing how this incident will impact or change his/her future practice. The incidents may be recorded by a peer, mentor, supervisor, colleague or the student himself. If the incident is submitted by a person other than the student, the student will be prompted and expected to input a response to the critical incident submission.

The above creative components of the portfolio must, in turn, be balanced with a structured component that can be evaluated. ACGME contemplates domains of competence related to patient care, medical knowledge, practice-based learning, interpersonal and communication skills, professionalism, practice-based learning and improvement and systems-based practice. Due to the problems in achieving acceptable reliability and validity of unstructured portfolios, the present invention weighs the balance of the portfolio in the direction of structured components. This permits study of the reliability and validity of the individual structured assessment tools rather than relying on the global reliability and validity of the portfolio as a whole. The underlying premise is that acceptable reliability and validity of the tools will insure acceptable reliability and validity of the portfolio.

In keeping with the premise that competence cannot be evaluated by a single global tool, the structured component of the portfolio contains a variety of assessment tools that can be used to evaluate each of the six ACGME domains of competence. Based on earlier work in which benchmarks and thresholds for each of the six domains were developed, the evaluation of specific benchmarks was delegated to particular clinical settings in which the tasks could best be accomplished. At the completion of training, all of the benchmarks will have been evaluated within the context of the appropriate clinical setting. Thus, at the completion of each clinical rotation, the faculty evaluator receives a rotation-specific evaluation that mirrors the goals for that particular clinical experience, as well as a number of benchmarks that are likewise appropriate to the specific clinical setting.

Listed below is an array of assessment tools that will be used to evaluate each of the six ACGME competencies.

Patient care:

Assignment of thresholds for given benchmarks

Rotation-specific faculty evaluations that parallel the goals for the rotation

Observed history and physical examination

Critical incidents (an event/outcome that was particularly good or bad)

Procedure logs

Continuity logs

Inpatient logs.

Medical Knowledge:

Assignment of thresholds for given benchmarks

Rotation specific faculty evaluations that parallel the goals for the rotation

In-training examination of the American Board of Pediatrics

Self-assessment of rotation specific objectives

Evidence-based practicum and presentation

Critically appraised topic (formal exercise in evidence-based medicine that forces the writer to critically evaluate an article in the medical literature and apply the evidence to a question raised in the care of a patient)

Practice-based Learning and Improvement:

Assignment of thresholds for given benchmarks

Focused practice improvement project in the continuity clinic setting (data collection form for practice audit, summary statement of intervention and outcome, reflective statement of change in practice as a result of intervention)

Critical incidents

Conference attendance log

Interpersonal and Communication Skills:

Assignment of thresholds for given benchmarks

Rotation specific faculty evaluations that parallel the goals for the rotation

360-degree evaluation

Professionalism:

Assignment of thresholds for given benchmarks

Critical incidents

Systems-based Practice:

Assignment of thresholds for given benchmarks

Documentation describing potential expansion of the practice improvement intervention described above considering resources outside the immediate health care delivery environment

Documentation of a systems error with strategies to positively impact the system and eliminate the error

No existing program or methodology provides such a comprehensive structure. An exemplary array of assessment tools in each of the six domains can be categorized as follows.

For some of the benchmarks, new tools had to be developed to assess whether benchmarks have been achieved. These tools include a direct, observed history and physical examination; a critically appraised topic; an evidence-based medicine journal club; a quality improvement project; and two projects to assess systems-based practice—one in which the learner navigates the system for a patient with a particular problem and in the other identifies a system error and strategies to impact that error. Each is described below. Testing the reliability and validity of these new tools will be the next challenge.

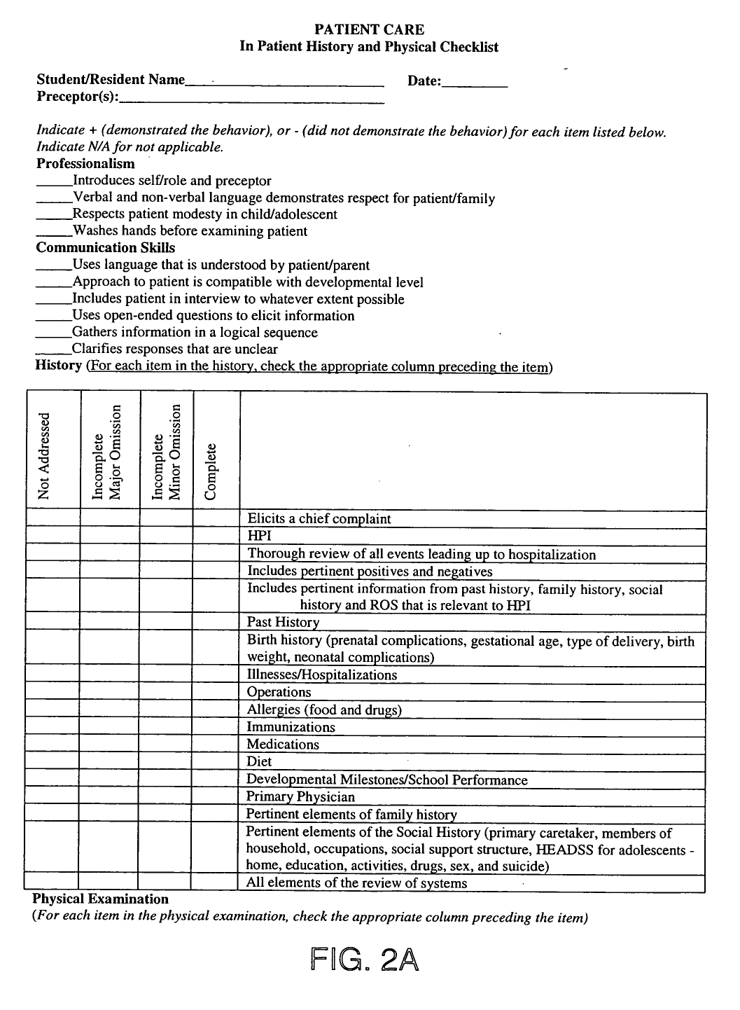

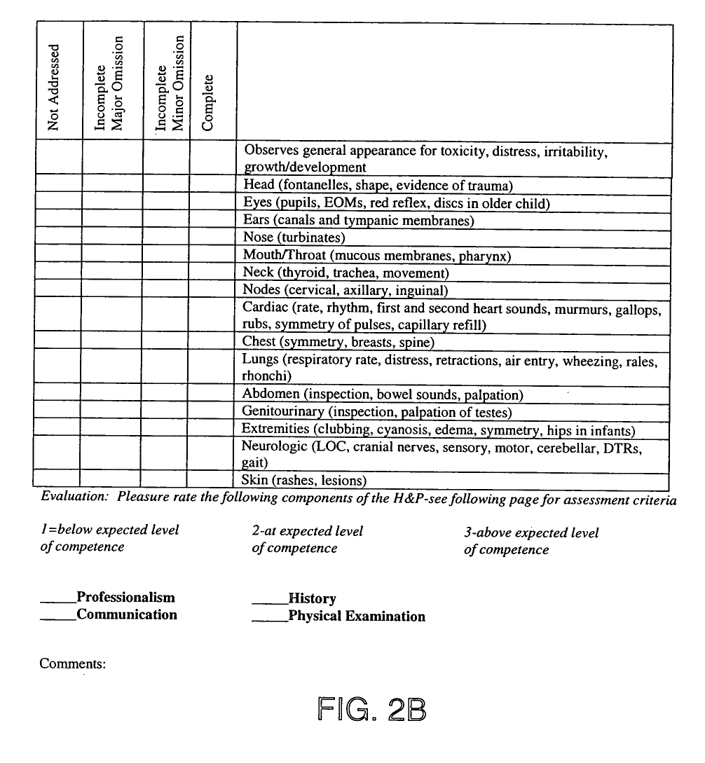

Using the background information available on the clinical evaluation exercise that has been developed in internal medicine, the invention comprises methodology to assess resident competence in performing a pediatric history and physical examination that comprises a number of critical benchmarks within the domain of patient care.²⁶⁻²⁸ Every resident is assessed doing a complete history and physical on two occasions during the first year of training, and feedback regarding performance is given. Exemplary criteria to evaluate the physical examinations are set forth in FIGS. 2A-2B.

What remains to be addressed is where to set the threshold for the achievement of competence at this level and other levels of experience, thereby providing a binary indicator (pass/fail) of competence. Taking this a step further, the ability to define threshold criteria for junior students and subinterns, in addition to residents, would allow the development of entry level competencies for our residents and begin to scratch the surface of providing a continuum of medical education through the undergraduate and graduate years.

In the present embodiment, based on the criteria illustrated in FIGS. 2A-2B, it is proposed that the following criteria should be used as a basis for studying the assessment tool. Based on collection of such data for a larger sample over time and/or on a national scale, it is contemplated that modification of the criteria based on data gleaned from the invention can be used to further develop even more effective evaluation criteria for the portfolio.

For assessment of professionalism and communication skills, the following criteria should be used based on the level of the student, resident or intern. Here MS2 corresponds to a student having completed a second year of medical school training, MS3 corresponds to a student having completed a third year of training, and MS4 corresponds to a student having completed a fourth year of training.

For a rating at the expected level of competence, MS2 and MS3 students should demonstrate at least three of the four professionalism behaviors and at least three of the six communication skill behaviors.

MS4 students should demonstrate at least three of the professionalism behaviors and four of the six communication skill behaviors.

Interns should demonstrate at least three of the professionalism behaviors and at least five of the six communication skill behaviors.

For a rating above the expected level of competence, MS2 and MS3 students should demonstrate all professionalism behaviors and four of the six communication behaviors. MS4 students should demonstrate all of the professionalism behaviors and at least five of the communication behaviors. Interns should demonstrate all professionalism and communication behaviors.

For evaluation of assessment of history and physical examination based on the criteria of FIGS. 2A-2B, in order to be judged at the expected level of competence, a student, resident or intern may not have more than one of the following bulleted items in the history category and/or the physical examination category. For example, one bulleted item may appear in the history category and one bulleted item may appear in the physical examination category.

MS2

2 not addressed

2 major omissions

1 not addressed and 1 major omission

4 minor omissions

MS3

1 not addressed and 1 minor omission

1 major and 1 minor omission

4 minor omissions

MS4

4 minor omissions

Interns

3 minor omissions

In order to be rated at above the expected level of competence, a student, intern or resident may not have more than one of the following bulleted items in the history and the physical examination category.

MS2

2 not addressed

2 major omission

1 not addressed and 1 major omission

4 minor omissions

MS3

1 not addressed and 1 minor omission

1 major omission and 1 minor omission

4 minor omissions

MS4

4 minor omissions

Interns

3 minor omissions

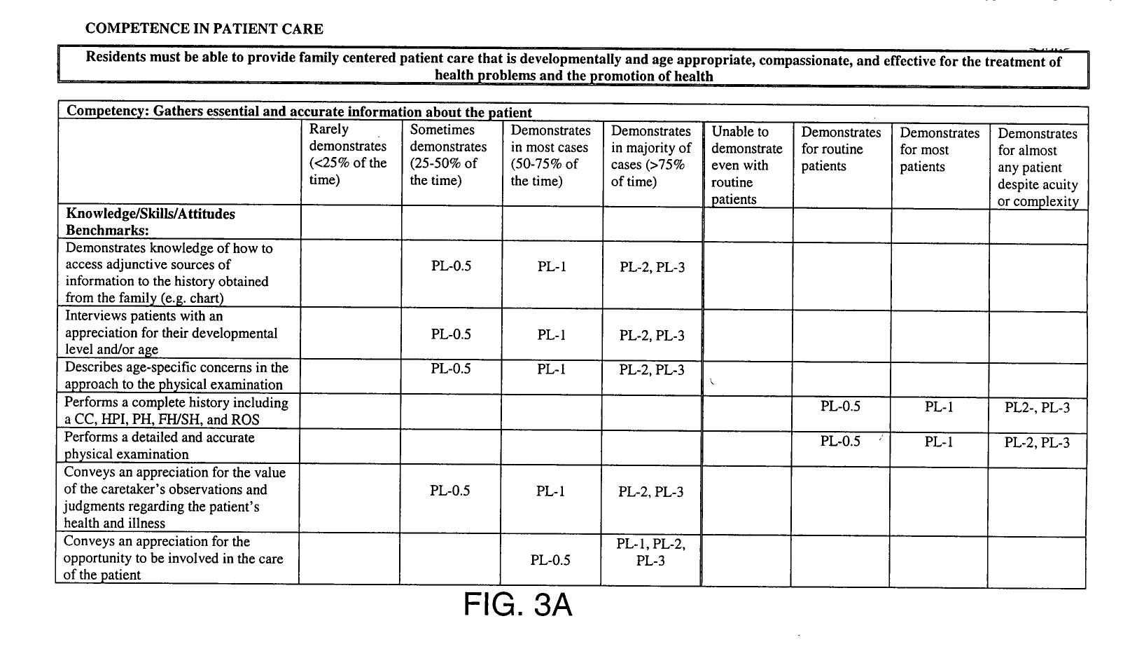

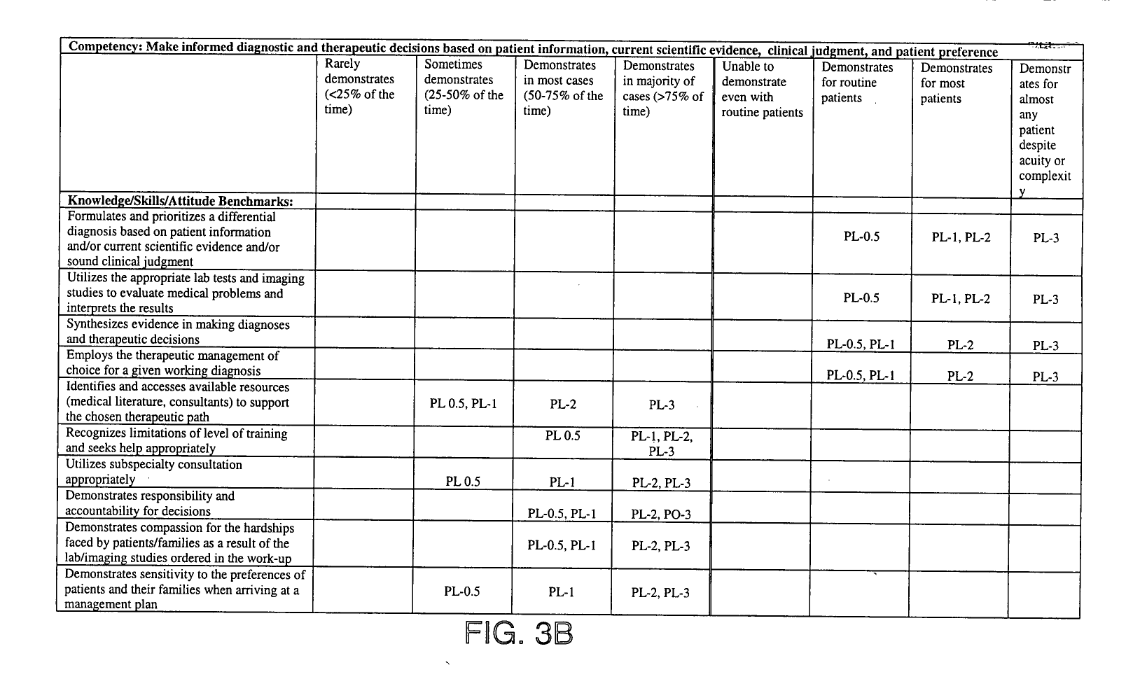

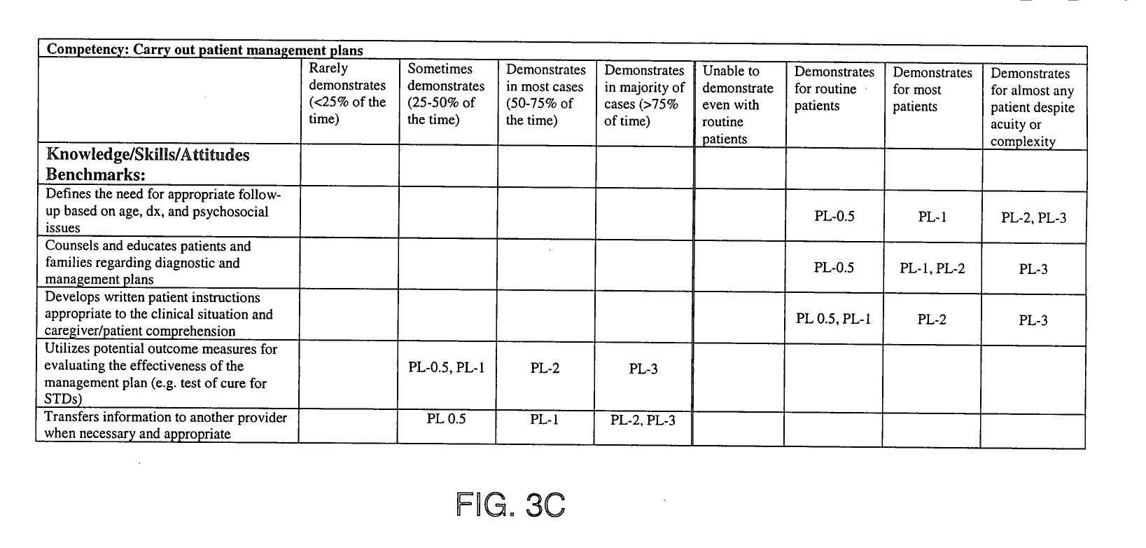

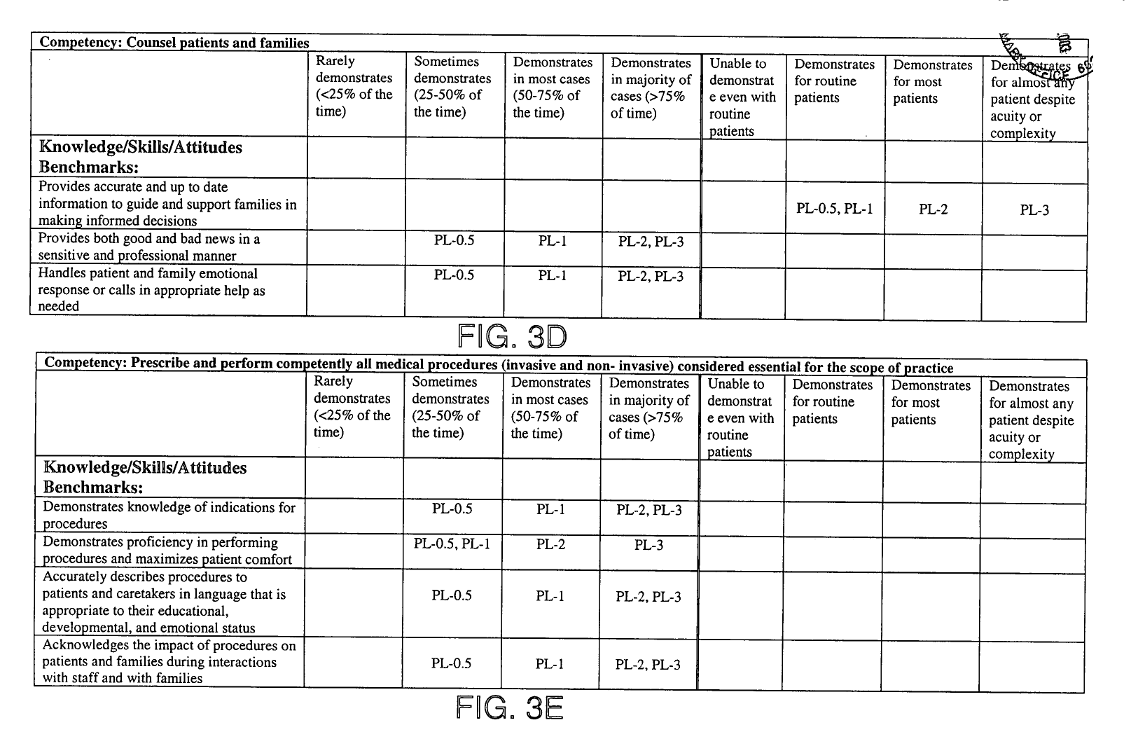

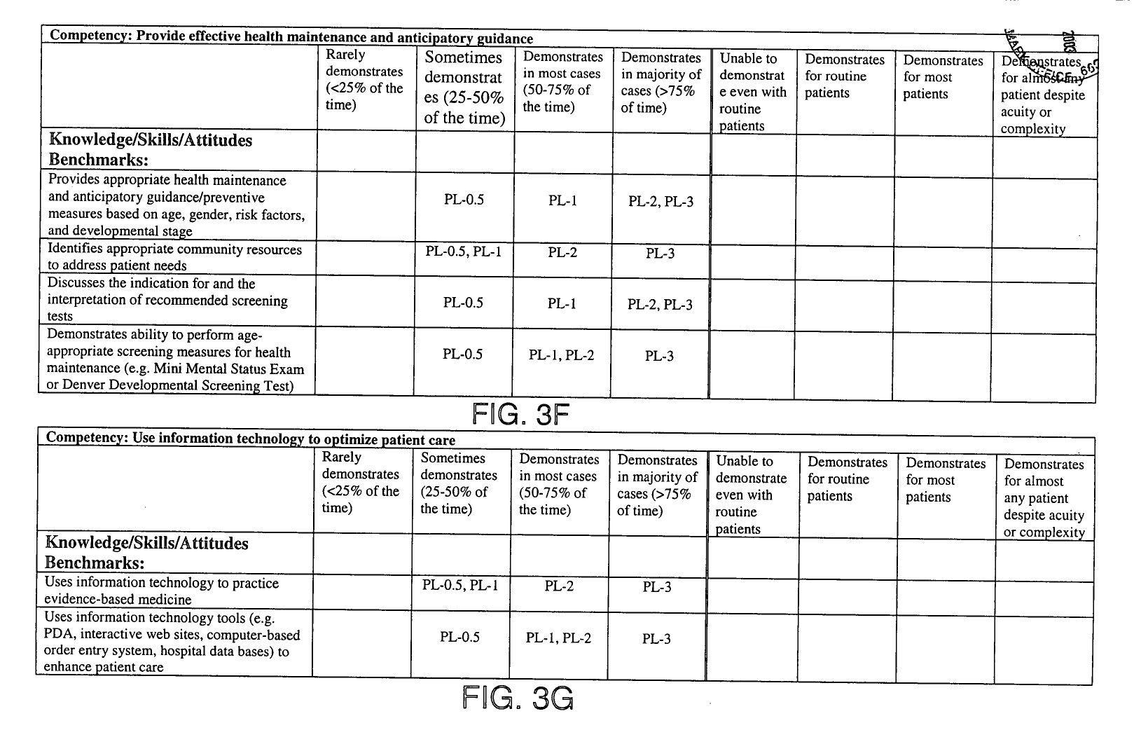

As a further aspect of the portfolio for assessment, FIGS. 3A-3G illustrate areas for evaluation in patient care based on percentage of observed events and observed events based on level of complexity. This assessment permits an evaluator to make true false assessments of observed behavior, which when accumulated over a period of time also permits the evaluator to determine whether the subject is meeting expected criteria based on skill level of the student. It is noted here that in the figures accompanying this text, the numbers in the table (PL 0.5, PL 1, PL 2 and PL 3) represent the pediatric level of training. PL 0.5 represents a mid point of the first year, and levels, 1-3 represent the end of each successive year of training. The thresholds for each level of training were established from data derived from a survey of pediatric program directors (n=206) with a 40% response rate. This survey was conducted by the inventor.

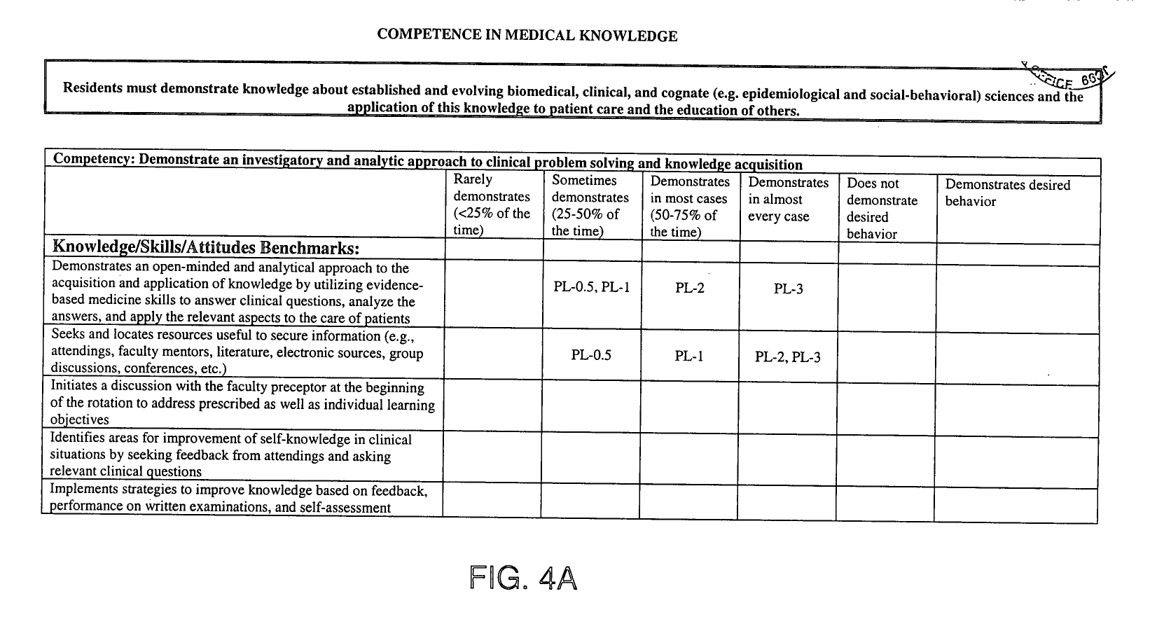

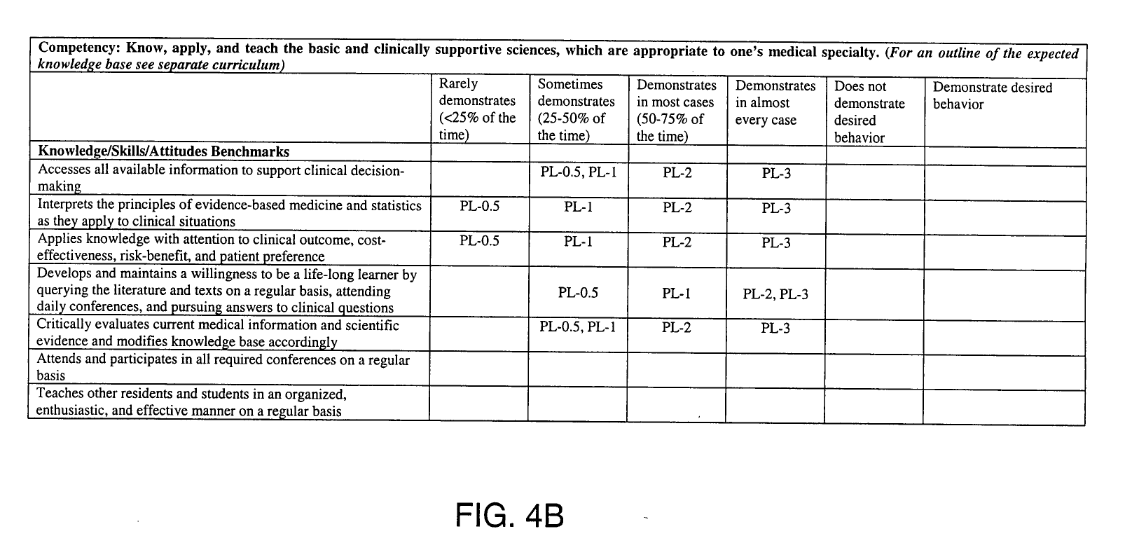

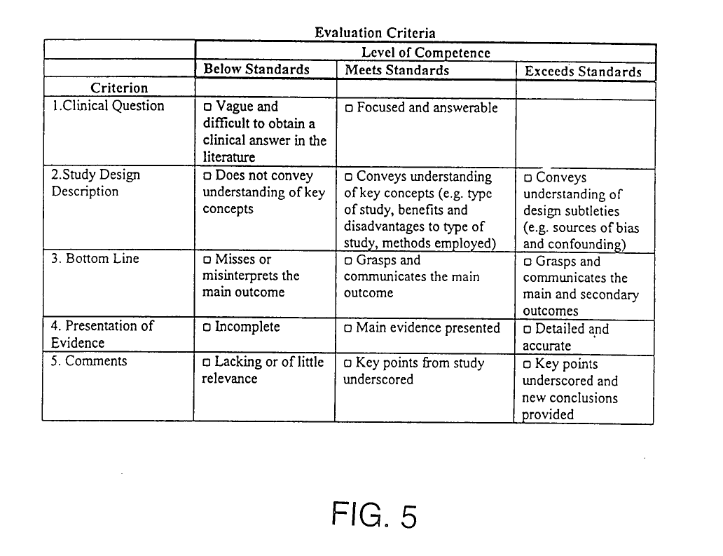

Turning to the domain of medical knowledge, not only must the learner demonstrate discipline-specific knowledge, but also the acquisition and application of new knowledge. Sample evaluation criteria are set forth in FIGS. 4A-4B. To enable residents to demonstrate these additional two competencies, the invention includes projects that the resident must complete during training. The first is a formal critical appraisal of an article that addresses a specific clinical question,⁴³ with the evaluation criteria for the present invention illustrated in FIG. 5.

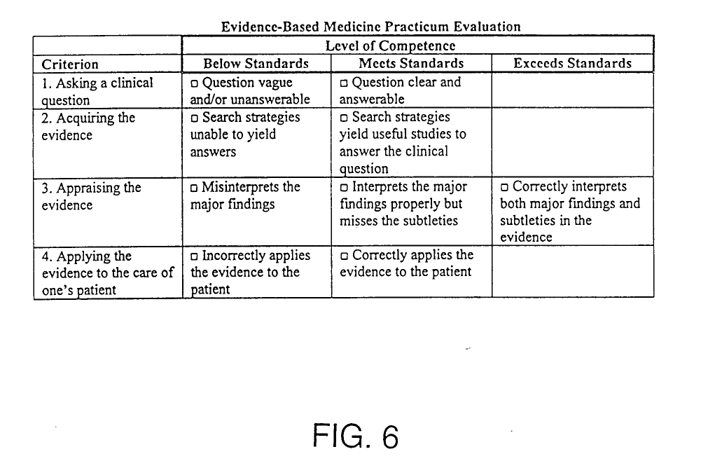

The second is an evidence-based medicine practicum in which the resident conducts an evidence-based search on a topic and delivers a journal club critiquing the discovered evidence. In particular, based on a patient encounter, the student must choose an answerable clinical question, perform a literature search to answer the clinical question with the best available evidence; appraise the evidence and critically evaluate the articles that resulted from the search and apply the evidence for the particular patient. FIG. 6 illustrates sample criteria for evaluating this exercise.

For both the first and second projects describe above, as well as others described later, transparency of the portfolio is critical for both the learner and the evaluator.⁷ Guidelines for completing tasks and projects are explicitly outlined and the criteria for grading clearly defined and readily available. No current literature describes a similar tool upon which to draw inferences about reliability and validity. The premise behind these tools, however, is not dissimilar from another tool described in the literature that has been referred to as the “triple jump exercise.”²⁹ The latter refers to an evaluation process that uses a case presentation, a literature search and finally an examination that assesses application of the medical literature to the case. The inventive “triple jump” provided here includes clinical question/topic definition, literature search, and application of literature in completing either the critical appraisal or delivering the evidence-based journal club.

The principles outlined above were also applied to the development of new tools to evaluate competence in the domains of practice-based learning and improvement and systems-based practice. For practice-based learning, all residents who function as a group practice within the continuity clinic setting will complete a team audit of some aspect of their practice. This audit will include identification of a clinical problem, chart review, development and implementation of an intervention, and post-intervention chart review. Taking this a step further to address the component competencies of systems-based practice, the residents will address how and what resources exist to address the identified problem outside of their own practice and within the context of the greater health care delivery system. Also as part of systems-based practice, residents will be called upon to document a systems-error and strategies that could be applied to impact this error.

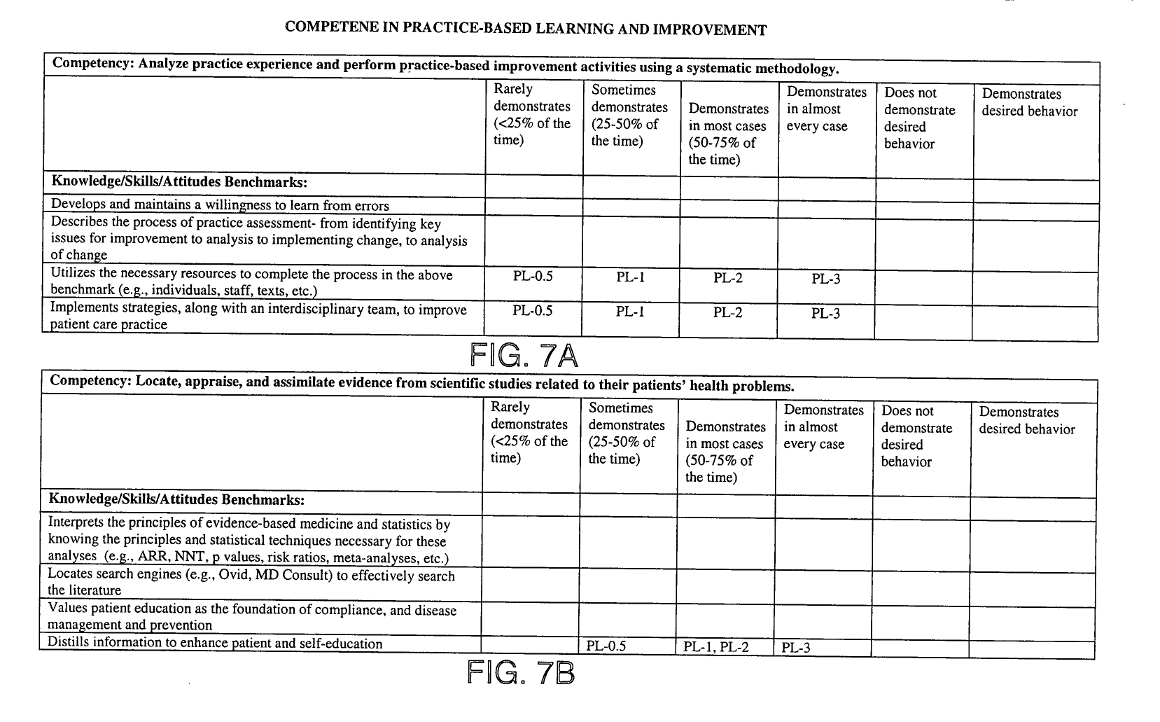

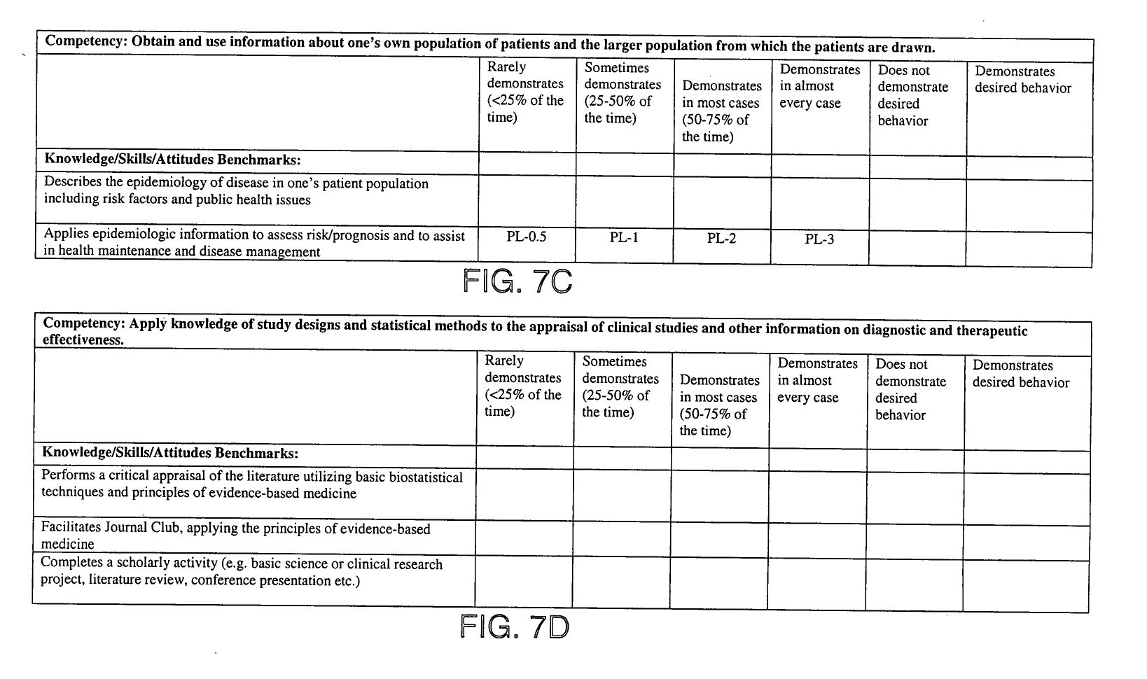

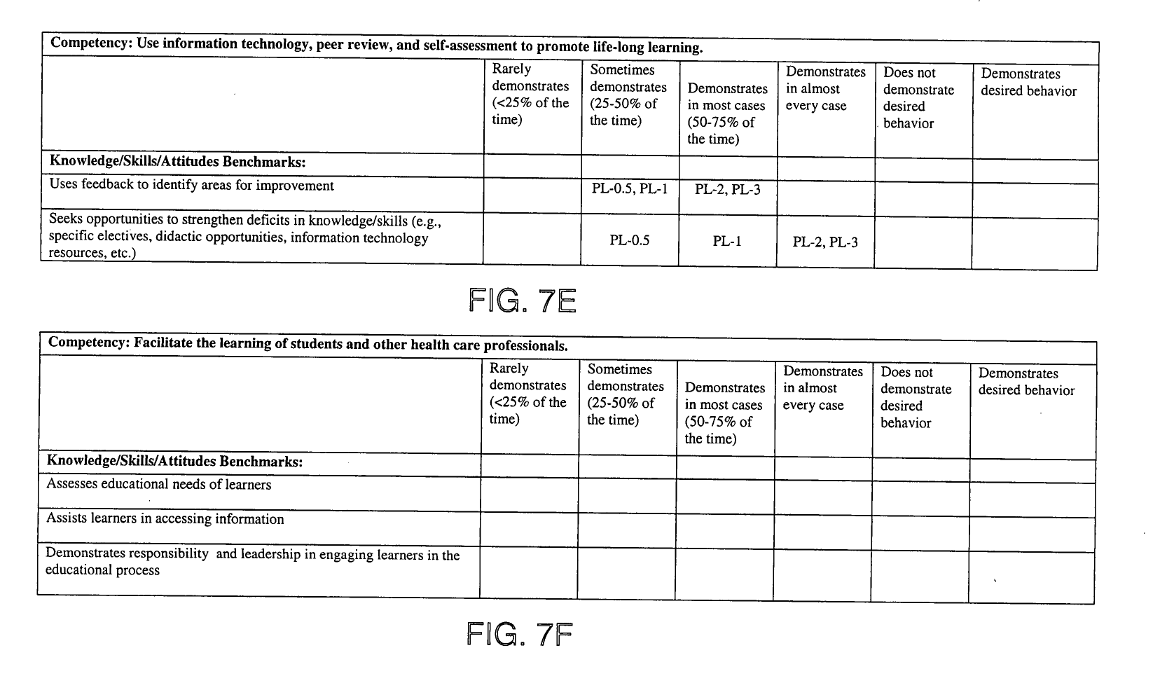

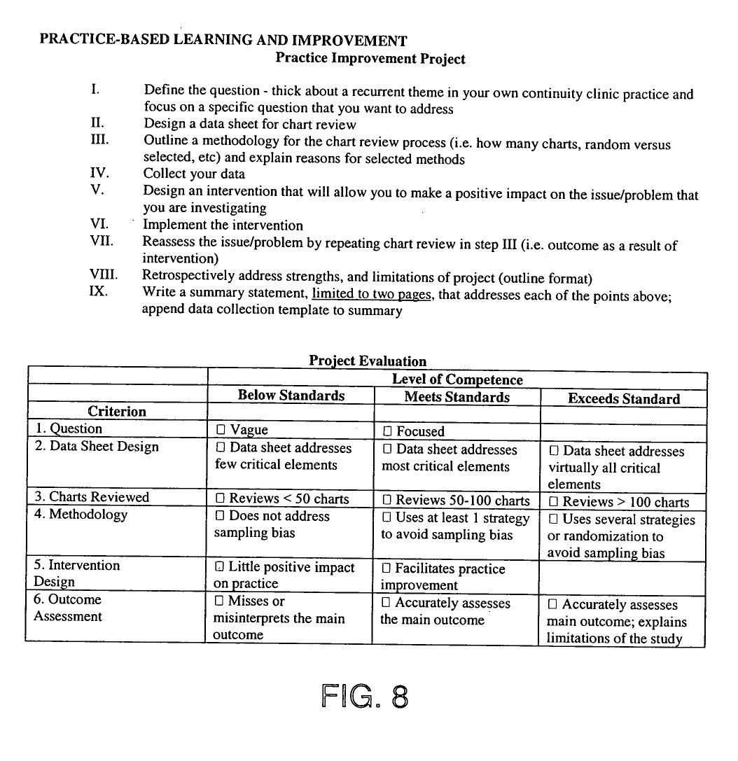

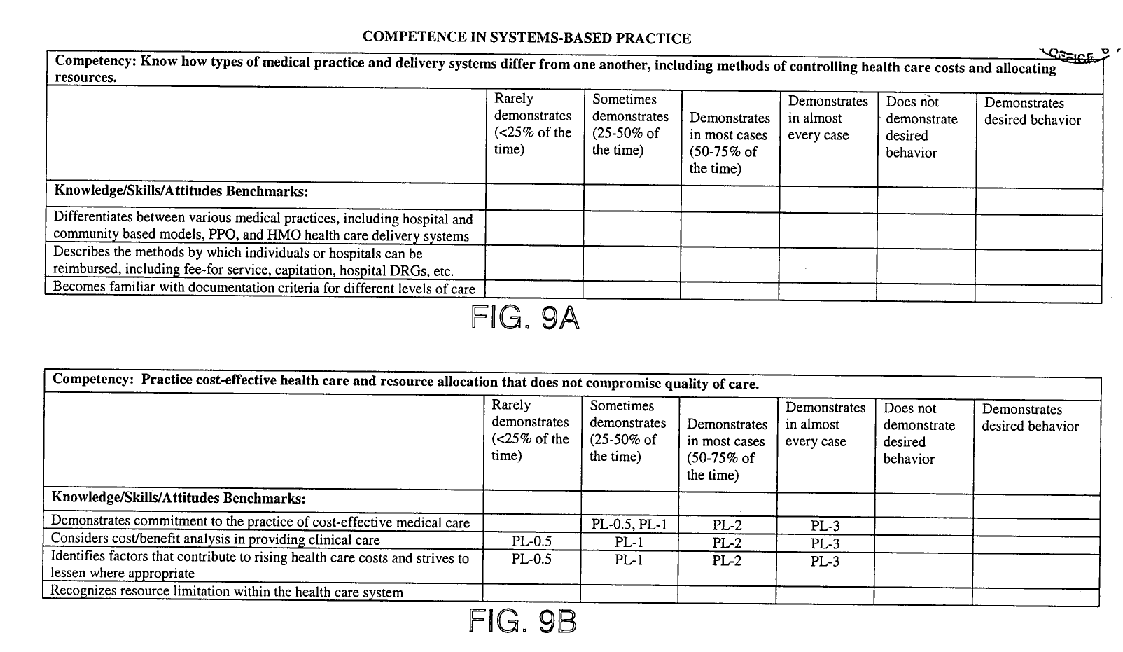

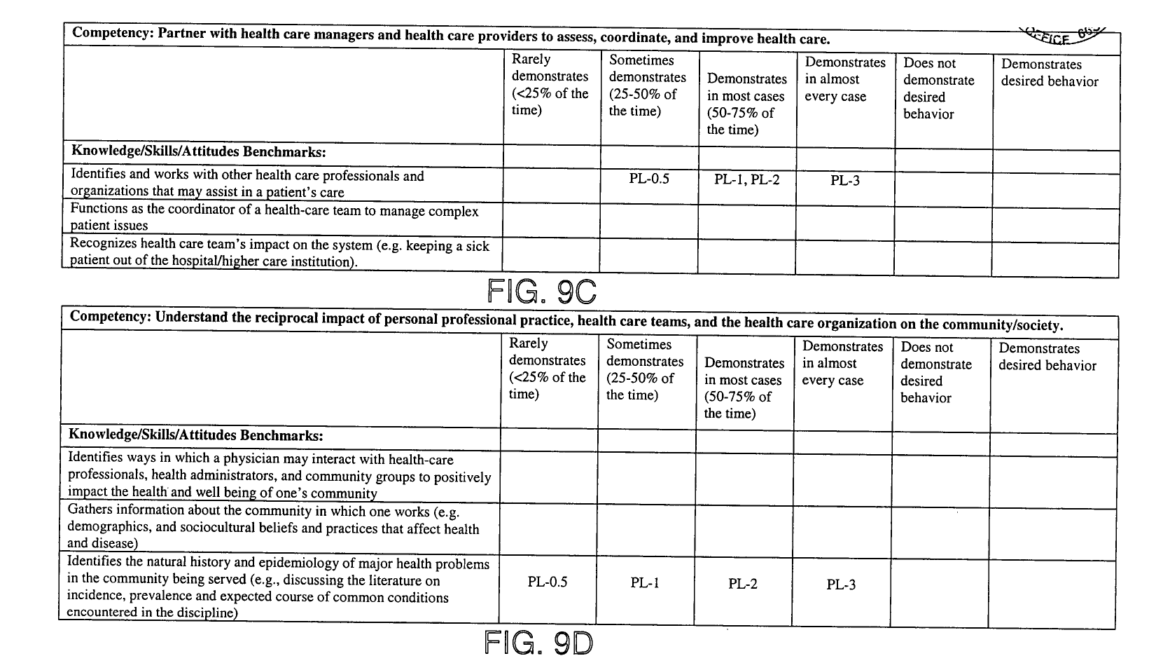

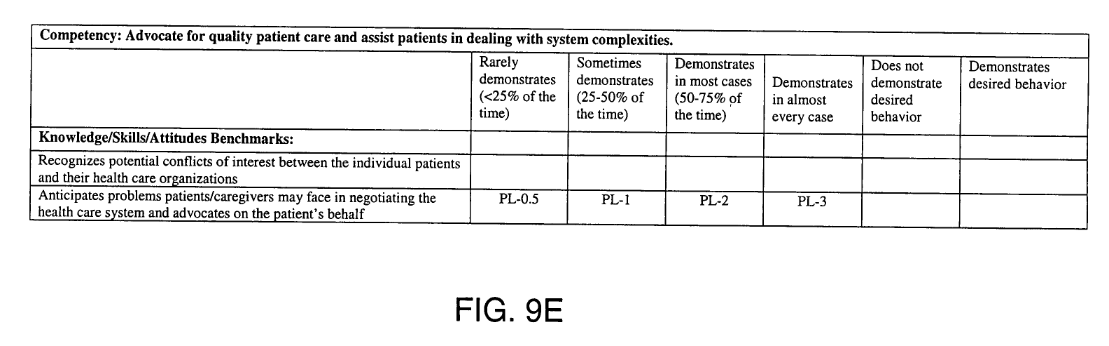

FIGS. 7A-7F illustrate criteria for evaluating practice-based learning of a subject based on binary observations compiled for a particular behavior. FIG. 8 illustrates criteria for practice-based learning based on additional qualitative parameters. FIGS. 9A-9E set forth criteria for evaluating competency in understanding and navigating systems-based care.

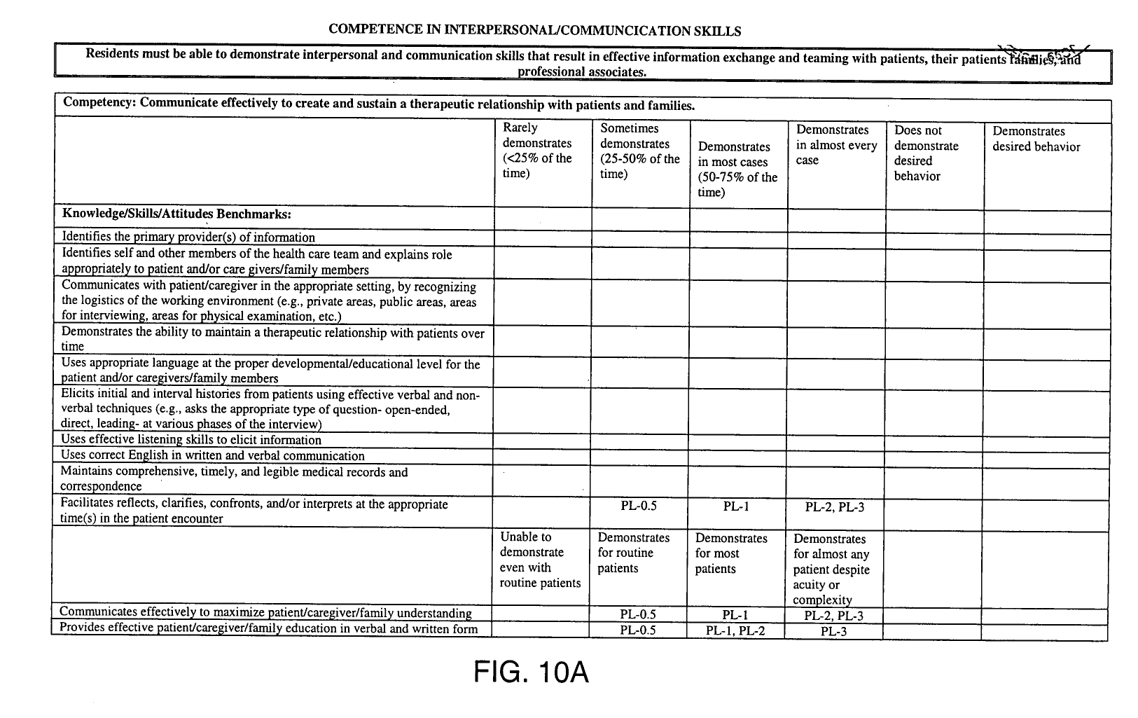

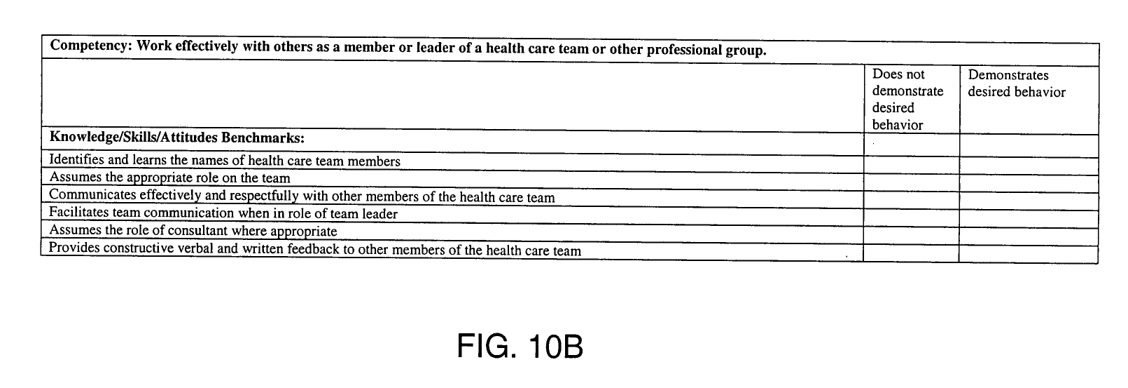

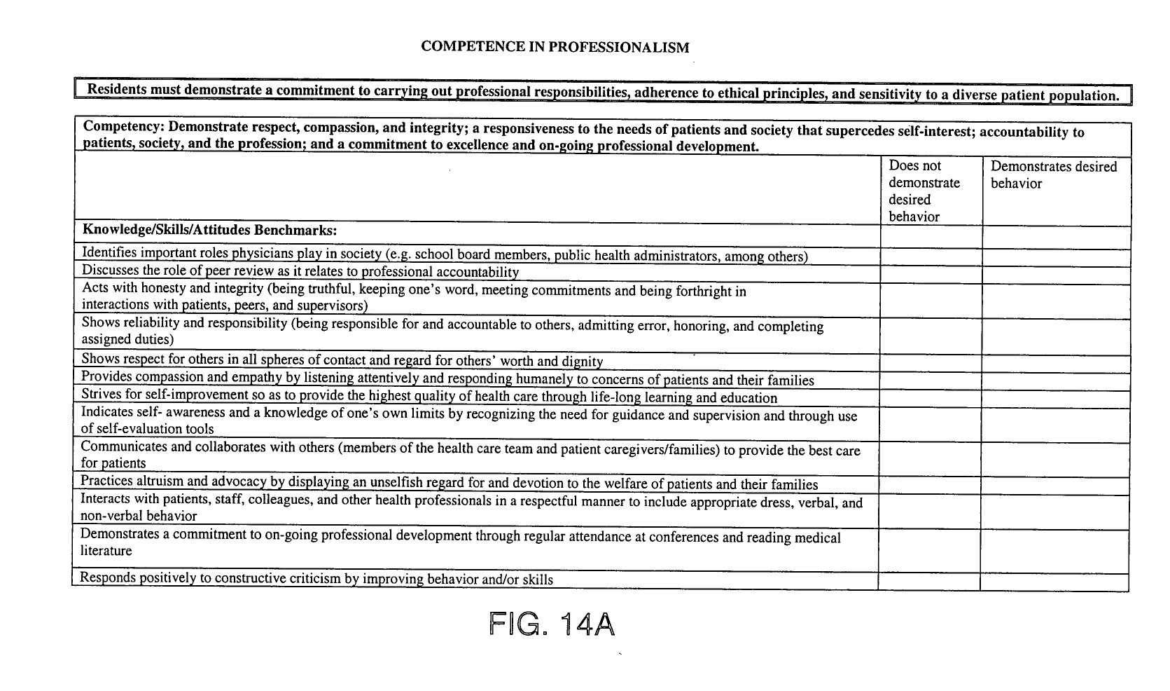

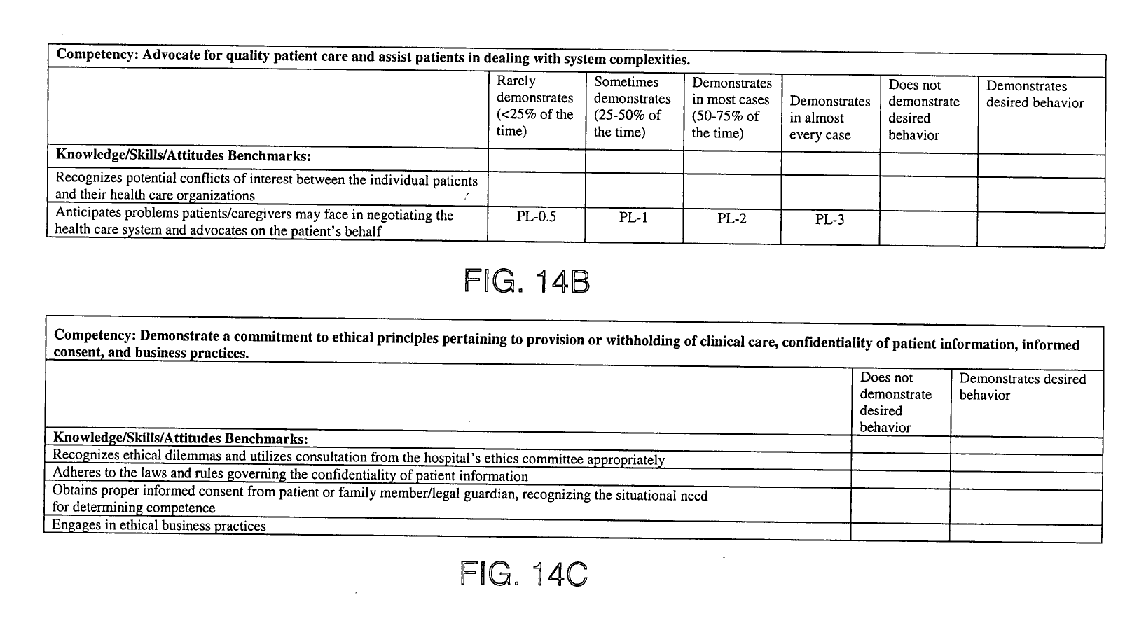

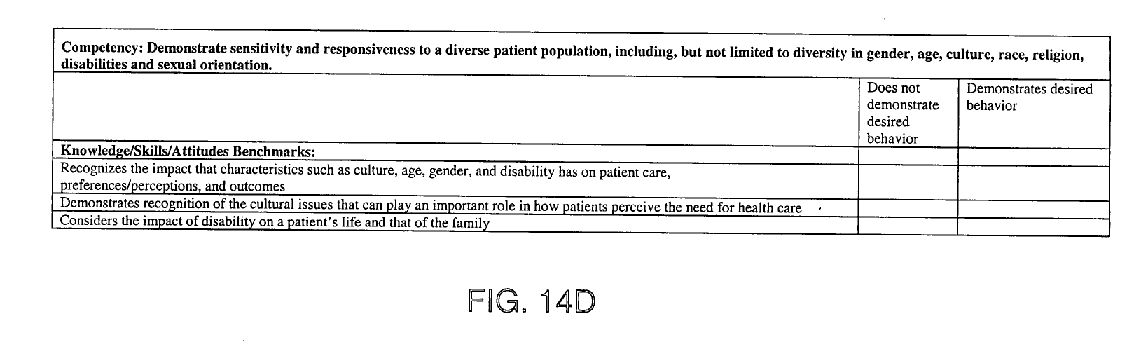

For the domains of professionalism and interpersonal and communication skills, FIGS. 10A-10B illustrate criteria for communication and interpersonal skills, and FIGS. 14A-14D illustrate those for professionalism. Additionally, a 360-degree evaluation was designed. A full 360-degree evaluation requires a self-assessment, as well as assessments by patients, nurses, peers, and supervising residents and faculty, as schematically illustrated by FIG. 11. The medical literature provides no reports of a full 360-degree evaluation, but rather several papers that report on the ratings of housestaff by nurses and other allied health professionals, ³⁰⁻³³ by patients,^{34,35} and by faculty and peer evaluations.³⁶ There is only one study that addresses ratings by nurses, faculty and patients.³⁷ A unique feature of this tool is that it specifically addresses the benchmarks that in the aggregate describe the competency. The practicality of using a 360-degree evaluation comes into question if one hopes to achieve acceptable reliability. Based on the literature, a minimum of 100 patients, 50 faculty, and 10 -20 nurses are needed as evaluators. However, one must weigh the value of qualitative aggregate feedback from patients and groups of professionals to the career development of the resident against the need for quantitatively documenting acceptable reliability. The invention raises the potential of accruing these numbers of evaluations over the course of training as opposed to a single clinical block experience. Reliability in this instance will need to be tested.

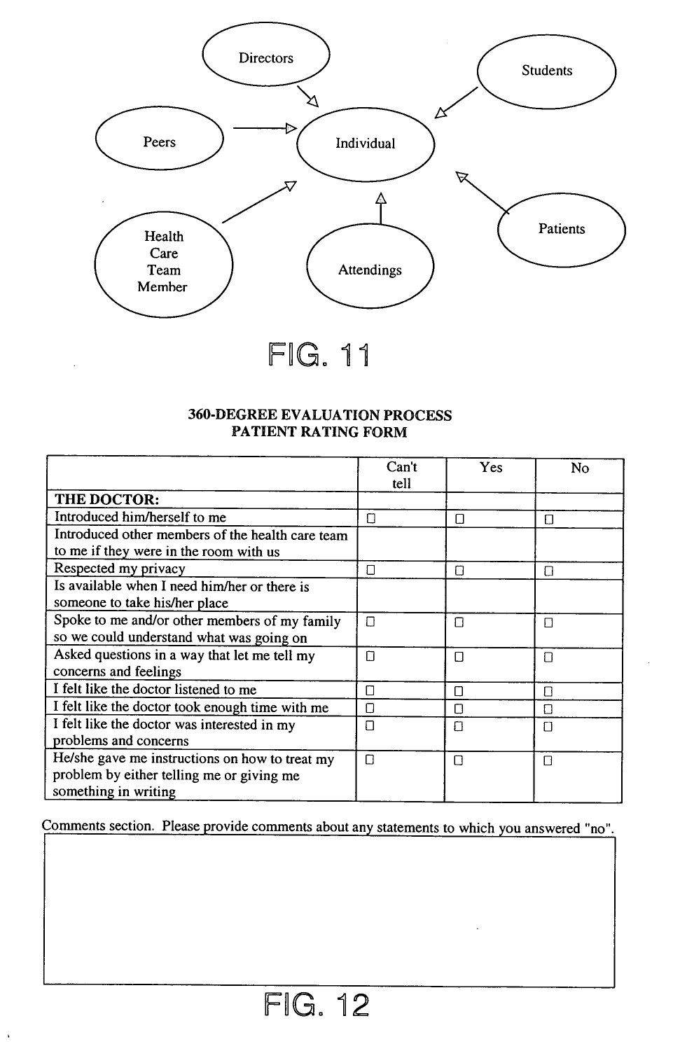

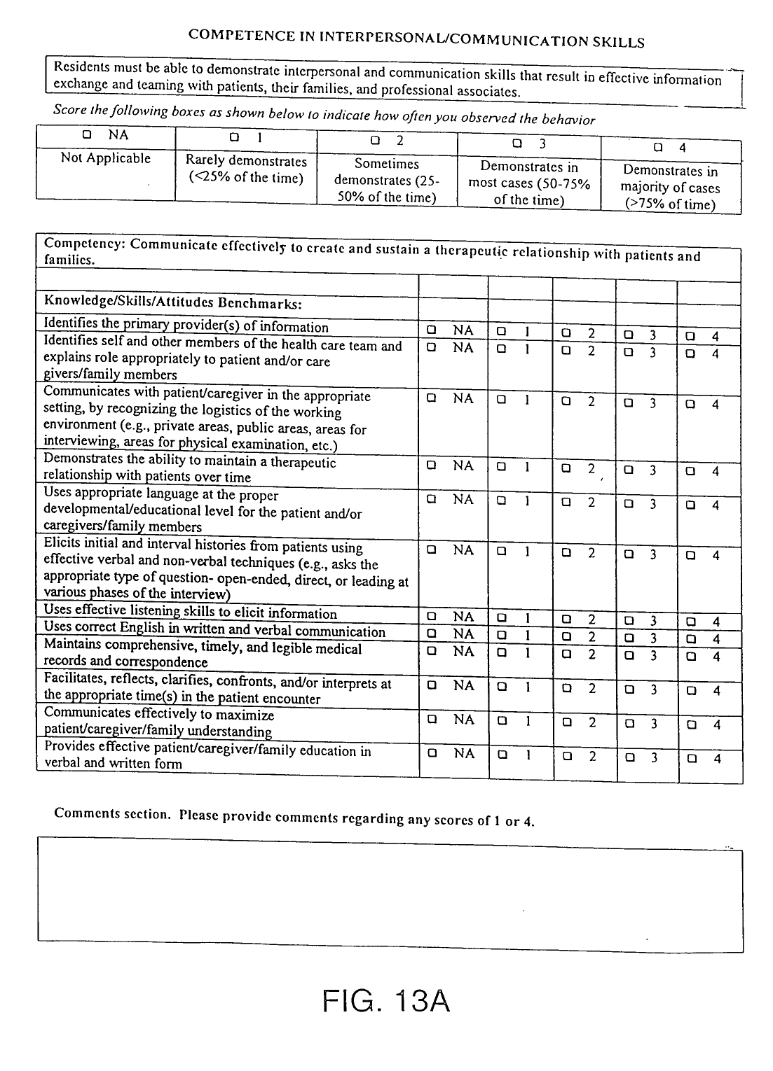

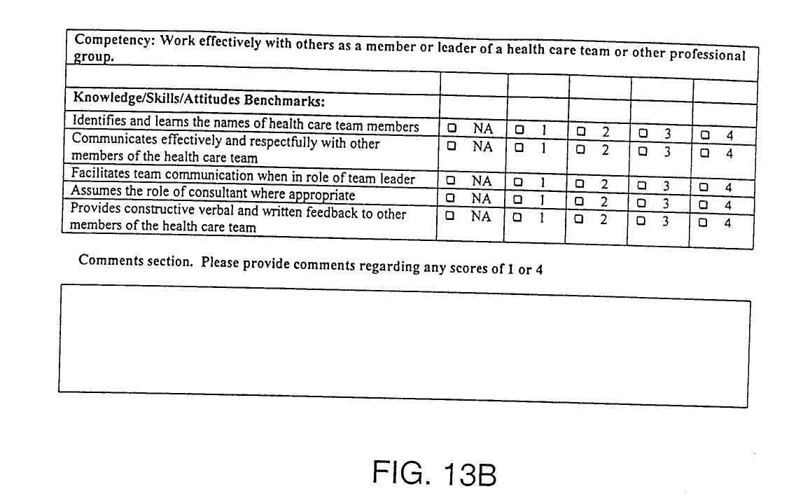

The present embodiment contemplates separate evaluation criteria to be offered to patients and colleagues in the 360 degree study. The patient evaluating criteria is illustrated by FIG. 12, and that for professional colleagues is illustrated by FIGS. 13A-13B.

As an adjunct to the evaluation strategies, the invention has several mechanisms for the resident to maintain logs and thus track patient care experiences, procedures, including documentation of competence for independent practice of procedures, and conference attendance. Entering this information into the portfolio in and of itself forces the learner to reflect, albeit on a superficial level, on their experiences/exposures.

The comprehensive data and web-based portfolio process of documentation of the data in the present invention will facilitate data gathering analysis for present and future use. Examples of which follow.

Resident

Individual

Survey electives to insure that they meet Board requirements.

Query the system for inter-rater reliability of faculty in evaluating benchmarks of competencies for individual residents.

Ability to determine whether residents have completed their evaluations of faculty and junior or senior colleagues.

Generate average score for each element of the 360 degree assessment tool by resident and by group of evaluator (i.e. patients versus nurses versus attendings).

For each resident, identify any benchmark where the expected threshold has not been reached.

Use relational data to compare thresholds for particular benchmarks across groups of learners (PL 1's and PL 2's etc.)

Numbers for evaluations completed versus number that should be completed (return rate).

Numbers of particular procedures by resident and level of training at which independent practice is achieved.

Patient logs for continuity clinic to assess volume/panel size and patient mix.

Monitor inpatient experience through logs (record #, age, discharge dx, day of admit, day of discharge, transfer to units with potential to add questions about outcomes and complications).

Number of mentor-resident encounters by specific resident through doc talk.

Correlation between self-assessments and mentor assessments.

Aggregate

Survey the self-assessment component of the goals and objectives by rotation/clinical experience to see which objectives are not being met.

For all residents query the system to determine % residents meeting the predetermined threshold for a particular benchmark.

Faculty

### Individual

Number of evaluations completed versus number that should be completed (return rate)′

Ability to develop composite scores for individual items on evaluations of faculty completed by residents.

### Aggregate

Sum the scores from the needs assessment (Likert scale which addresses teaching ability/strength of clinical experience) completed by individual residents.

### National

Ability to collect national data would allow us to study educational assessment tools for reliability and validity and to look at trends and outcomes of the educational experience.

The final lesson regarding the critical nature of reliability testing for both individual assessment tools and the portfolio in its entirety should be the focus of medical educators over the next several years. Although some benchmarks of some of the domains of competence are currently measurable by valid and reliable assessment tools (e.g., OSCE³⁸ for some aspects of patient care), many will require both the development and reliability and validity testing of new tools. The present web-based methodology will allow such reliability analysis to occur.

While the invention has been described with regard to an exemplary embodiment, one skilled in the art will understand that obvious modifications can be made without departing from the spirit and scope of the invention. For example, while the description refers to evaluation at a single medical program and program rotation, the web-based methodology permits data and evaluation to be collected on a wider, national scale. The results of a broader study can be used to better assess the evaluation criteria reliability. Additionally, the network environment in which the present portfolio is implemented can comprise the Internet or any local or wide area network. The details of the network can be determined by one of ordinary skill in the art and the details thereof are omitted here. As one example, the portfolios can be stored in a central database and accessed for input by students, faculty evaluators and administrators via the Internet, dial up service or wide or local network using PC's. Adequate security measures for reading of individual portfolios would also be provided. One skilled in the art would similarly be able to write a suitable program to implement the web-based portfolio of the present invention.

### REFERENCES

1. Outcomes, Project, http://www.acgme.org. Accessed Jan. 2, 2003. The Accreditation Council for Graduate Medical Education, Chicago, Ill., 2001.

2. Carraccio C, Wolfsthal SD, Englander R, Ferentz K, Martin C. Shifting paradigms: From Flexner to competencies. Acad Med 2002; 77:361-7.

3. Snadden D, Thomas M. The use of portfolio learning in medical education. Med Teach 1998; 20:192-00.

4. Turnbull J. What is . . . normative versus criterion-referenced assessment. Med Teach 1989; 1:145-50.

5. Challis M. AMEE medical education guide no. 11 (revised): Portfolio-based learning and assessment in medical education. Med Teach 1999; 4:437-40.

6. Mathers NJ, Challis MC, Howe AC, Field NJ. Portfolios in continuing medical education-effective and efficient? Med Educ 1999; 33:521-30.

7. Freedman Ben-David M. AMEE guide No. 24. Portfolios as a method of student assessment. Med Teach 2001; 23:535-51.

8. Schön D. Educating the Reflective Practitioner. San Francisco: Jossey-Bass, Inc., 1987.

9. Parboosingh J. Learning portfolios: Potential to assist health professional with self-directed learning. J Cont Educ Health Prof 1996; 16:75-81.

10. Pitts J, Coles C, Thomas P. Enhancing the reliability in portfolio assessment: Shaping the portfolio. Med Teach 2001; 23:351-6.

11. Pitts J, Coles C, Thomas P, Smith F. Enhancing reliability in portfolio assessment: discussions between assessors. Med Teach 2002; 24:197-01.

12. Finlay IG, Maughan TS, Webster DJ. A randomized controlled study of portfolio learning in undergraduate cancer education. Med Educ 1998; 32:172-6.

13. Lonka K, Slotte V, Halttunen M, et al. Portfolios as a learning tool in obstetrics and gynaecology undergraduate training. Med Educ 2001; 35:1125-30.

14. Challis M, Mathers NJ, Howe AC, Field NJ. Portfolio-based learning: continuing medical education for general practitioners—a mid-point evaluation. Med Educ 1997; 31:22-6.

15. Campbell C, Parboosingh JT, Tunde Gondocz S, et al. Study of physician's use of a software program to create a portfolio of their self-directed learning. Acad Med 1996; 71:49-51 (suppl).

16. Pitts J, Coles C, Thomas P. Educational portfolios in the assessment of general practice trainers: Reliability of assessors. Med Educ 1999; 33:515-20.

17. Jensen GM, Saylor C. Portfolios and professional development in the health professions. Eval Health Prof 1994; 17:344-57.

18. Fung MFKF, Walker M, Fung KFK, et al. An internet-based learning portfolio in resident education: the KOALA™ multicentre programme. Med Educ 2000; 34:474-9.

19. Rosenberg ME, Watson K, Paul J, Miller W, Harris I, Valdivia TD. Development and implementation of a web-based evaluation system for an internal medicine residency program. Acad Med 2001; 76:92-5.

20. Dornan T, Lee C, Stopford A. SkillsBase: A web-based electronic learning portfolio for clinical skills. Acad Med 2001; 76:542-3.

21. Stewart J, O'Halloran CO, Barton JR, Singleton SJ, Harrigan P, Spencer J. Clarifying the concepts of confidence and competence and competence to produce appropriate self-evaluation measurement scales. Med Educ 2000; 34:903-9.

22. Ward M, Gruppen L, Regehr G. Measuring self-assessment: Current state of the art. Adv Health Sci Educ Theory Pract 2002; 7:63-80.

23. Gordon MJ. A review of the validity and accuracy of self-assessments in health professions training. Acad Med 1991; 66:762-9.

24. Regehr G, Hodges B, Tiberius R, Lopchy J. Measuring self-assessment skills: An innovative relative ranking model. Acad Med 1996; 71:52-4 (suppl).

25. Altmaier EM, McGuinness G, Wood P, Ross RR, Bartley J, Smith W. Defining successful performance among pediatric residents. Pediatrics 1990; 85:139-43.

26. Norcini JJ, Blank LL, Arnold GK, Kimball HR. The mini CEX: A preliminary investigation. Ann Intern Med 1998; 123:795-9.

27. Holmboe E, Hawkins RE. Methods for evaluating the clinical competence of residents in internal medicine: A review. Ann Intern Med 1998; 129:42-8.

28. Kroboth FJ, Hanusa BH, Parker S, et al. The inter-rater reliability and internal consistency of a clinical evaluation exercise. J Gen Intern Med 1992; 7:174-9.

29. Smith RM. The triple-jump examination as an assessment tool in the problem-based medical curriculum at the University of Hawaii. Acad Med 1993; 68:366-72.

30. Butterfield PS, Mazzaferri EL. A new rating form for use by nurses in assessing residents' humanistic behavior. J Gen Intern Med 1991; 6:155-61.

31. Butterfield PS, Mazzaferri EL, Sachs LA. Nurses as evaluators of the humanistic behavior of internal medicine residents. J Med Educ 1987; 62:842-9.

32. Kaplan CB, Centor RM. The use of nurses to evaluate houseofficers' humanistic behavior. J Gen Intern Med 1990; 5:410-4.

33. Linn LS, Oye RK, Cope DW, DiMatteo MR. Use of nonphysician staff to evaluate humanistic behavior of internal medicine residents and faculty members. J Med Educ 1986; 61:918-20.

34. Tamblyn R, Gebo KA, Hellman DB. The feasibility and value of using patient satisfaction ratings to evaluate internal medicine residents. J Gen Intern Med 1994; 9-146-52.

35. Matthews DA, Feinstein AR. A new instrument for patients' rating of physician performance in the hospital setting. J Gen Intern Med 1989; 4:14-22.

36. Van Rosendaal GMA, Jennett PA. Comparing peer and faculty evaluations in an internal medicine residency. Acad Med 1994; 69:299-03.

37. Wolliscroft JO, Howell JD, Patel BP, Swanson DB. Resident-patient interactions: the humanistic qualities of internal medicine residents assessed by patients, attending physicians, program supervisors and nurses. Acad Med 1994; 69:216-24.

38. Carraccio C, Englander R. The objective structured clinical examination: A step in the direction of competency-based education. Arch Pediatr Adolesc Med 2000; 154:736-41.

39. Davis MH, Friedman Ben-David M, Harden RM, et al. Portfolio assessment in medical students' final examinations. Med Teach 2001; 23:357-66.

40. Snadden D. Portfolios-attempting to measure the unmeasurable. Med Educ 1999; 33:478-9.

41. Wilkinson TJ, Challis M, Hobma SO, et al. The use of portfolios for assessment of the competence and performance of doctors in practice. Med Educ 2002; 36:918-24.

42. Murray E. Challenges in educational research. Med Educ 2002; 36:110-2.

43. Sackett DL, Richardson WS, Rosenberg W, Haynes RB Evidence-based Medicine: How to practice and teach EBM. New York: Churchill Livingstone, 1997).

1. A computer-implemented process for evaluating a subject in performance of a plurality of tasks in multiple areas of competence and at two or more levels of proficiency, wherein for a first task of a first area of competence, a binary condition is used to evaluate the subject and wherein for a second task of the first area of competence, a percentage indicator of acceptability is used to evaluate the subject, said process comprising:
evaluating the subject performing the first task according to the binary condition and storing a first task result to a computer-based portfolio for the subject,
evaluating the subject performing the second task over a period of time and storing a second task result to the portfolio,
changing the percentage indicator of acceptability based on a level of proficiency of the subject.

2. The process of claim 1, wherein the binary condition for the first task is evaluated independently from the percentage indicator for the second task.

3. The process of claim 2, wherein evaluating the second task occurs in observing the subject perform an action repeatedly over a period of multiple weeks.

4. The process of claim 1, wherein the subject compiles an ordered ranking of a plurality of behavioral characteristics at the beginning of the period of time, said ranking being stored in the portfolio.

5. The process of claim 4, wherein the plurality of behavioral characteristics include predetermined attributes to be ranked by multiple subjects undergoing evaluation and one or more individual attributes input by the subject.

6. The process of claim 4, wherein an evaluator of the subject compiles a second ordered ranking of the plurality of behavioral characteristics observed in the subject, said second ranking being stored to the portfolio.

7. The process of claim 4, wherein after the period of time elapses, the process further comprises:
re-evaluating the subject performing the first task according to the binary condition and storing a first task re-evaluation result to the portfolio;
re-evaluating the subject performing the second task over a second period of time according to a second percentage indicator of acceptability and storing a second task re-evaluation result to the portfolio, said second percentage indicator of the re-valuation of the second task being set according to a next higher level of proficiency.

8. The process of claim 7, wherein after the period of time elapses, said subject recompiles a second ordered ranking of the plurality of behavioral characteristics, said second ranking being stored in the portfolio with the first and second task results, and the first and second task re-evaluation results.

9. The process of claim 1, wherein the multiple areas of competence each respectively include an associated first task and an associated second task for evaluation, said process further comprising:
evaluating the subject performing the associated first task of multiple areas of competence according to respective binary conditions in the multiple areas of competence and storing respective first task results to the portfolio;
evaluating the subject performing the associated second task of multiple areas of competence according to respective percentage indicators in the multiple areas of competence and storing respective second task results to the portfolio.

10. The process of claim 9, wherein one of the multiple areas of competence comprises a third task evaluated based on degrees of difficulty encountered by the subject over the period of time, said process further comprising:
evaluating the subject performing the third task according to degree of difficulty and storing the result to the portfolio.

11. The process of claim 1, further comprising approving or disapproving the subject's performance based on contents stored to the portfolio.

12. The process of claim 1, wherein the process is implemented via Internet.

13. The process of claim 12, further comprising compiling evaluation results for multiple subjects, and wherein the first tasks and the percentage indicator of acceptability are adjusted based on evaluation results of the multiple subjects.

14. The process of claim 10, wherein the multiple areas of competence comprise criteria for medical school curricula comprising at least two of: patient care; medical knowledge; interpersonal and communication skills; professionalism; practice-based learning and improvement and systems-based care.

15. The process of claim 10, further comprising: entering textual comments to the portfolio in one or more of the areas of competence.

16. The process of claim 15, wherein the textual comments are entered by the subject being evaluated.

17. The process of claim 15, further comprising periodically sending electronic notices to the subject to perform at least one of reading, inputting and updating the portfolio.

18. The process of claim 15, further comprising: compiling a list of objectives to be achieved in the period of time into the portfolio, said list of objectives being input by the subject, and after the period of time elapses, displaying the list of objectives for review by the subject.

19. A computer readable medium for evaluating a subject in performance of a plurality of tasks categorized in multiple areas of competence and at two or more levels of proficiency, wherein for a first task of a first area of competence, a binary condition is used to evaluate the subject and wherein for a second task of the first area of competence, a percentage indicator of acceptability is used to evaluate the subject, said medium comprising:
computer-readable program means for evaluating the subject performing the first task according to the binary condition and storing the result to a portfolio for the subject being evaluated,
computer-readable program means for evaluating the subject performing the second task over a period of time and storing the result to the portfolio,
computer-readable program means for changing the percentage indicator of acceptability based on the level of proficiency of the subject.

20. The medium of claim 19, further comprising a computer-readable program means for ranking a plurality of behavioral characteristics at the beginning of the period of time, said ranking being stored in the portfolio, said and ranking being input by the subject being evaluated.
